(19) United States
(12) Patent Application Publication
(10) Pub. No.: US 2018/0339301 A1
(43) Pub. Date: Nov. 29, 2018

(54) AEROSOLIZED AIR SEALING OF ATTIC AND DUCTING

(71) Applicant: Owens Corning Intellectual Capital, LLC, Toledo, OH (US)

(72) Inventor: David H. Wolf, Newark, OH (US)

(21) Appl. No.: 15/977,020

(22) Filed: May 11, 2018

Related U.S. Application Data
(60) Provisional application No. 62/510,941, filed on May 25, 2017.

(51) Int. Cl. B05B 1/24; E04B 1/66; B05B 1/00

(52) U.S. Cl. CPC B05B 1/24; B05B 1/00; E04B 1/66

(57) ABSTRACT

Systems for and methods of simultaneously sealing a floor of an attic and ductwork in the attic with an aerosolized sealant are disclosed.

### CROSS REFERENCE TO RELATED APPLICATIONS

This application claims priority to and any benefit of U.S. Provisional Patent Application No. 62/510,941, filed May 25, 2017, the content of which is incorporated herein by reference in its entirety.

### FIELD

The general inventive concepts relate generally to air sealing and, more particularly, to systems for and methods of air sealing an attic and associated ducting.

### BACKGROUND

It is known to apply an aerosolized sealant to an enclosure, such as a duct/pipe or home, under pressure to seal cracks or small openings in the enclosure. These concepts are described, for example, in U.S. Pat. Nos. 5,522,930 and 5,980,984, as well as U.S. Pat. Pub. Nos. 2017/0073962 and 2017/0074746, the entire disclosures of which are herein incorporated by reference in their entirety.

Homebuilders today are challenged to improve the air tightness of buildings. This is a challenge because (1) how to air seal is not obvious (a knowledge gap), (2) many construction trades are involved in the process of creating penetrations in the building (a trade-accountability gap), and (3) multiple products are required to execute the air sealing (a product-accountability gap). Homebuilders are also challenged to improve the air tightness of the HVAC ductwork for many of the same reasons.

This combination of building sealing and duct sealing is particularly important in the southern portion of the United States, where the HVAC system is often in the attic and the attic presents a hot/hostile location from an energy efficiency standpoint. These states can reap big energy efficiency benefits from air sealing the attic floor and air sealing ducting in the attic. A solution that addresses these two locations (i.e., attic floor and attic ducts), even without air sealing the wall, could deliver a significant energy performance benefit.

Thus, there is an unmet need for systems for and methods of sealing only a portion (i.e., the attic) of a home. Accordingly, the general inventive concepts relate to systems for and methods of simultaneously sealing an attic floor and attic ducting with an aerosolized sealant that is deployed in the attic. This differs from conventional sealant methodologies, which are deployed within an entire house and do not address the ducts simultaneously.

### SUMMARY

The general inventive concepts contemplate systems for and methods of sealing an attic of a building with an aerosolized sealant. In some exemplary embodiments, ductwork in the attic is sealed contemporaneously with the sealing of the attic.

Other aspects, advantages, and features of the general inventive concepts will become apparent to those skilled in the art from the following detailed description, when read in light of the accompanying drawings.

### BRIEF DESCRIPTION OF THE DRAWINGS

For a fuller understanding of the nature and advantages of the general inventive concepts, reference should be had to the following detailed description taken in connection with the accompanying drawings, in which:

FIG. 1 illustrates a conventional system for sealing a home with an aerosolized sealant.

FIGS. 2A-2B illustrate a system for simultaneously sealing an attic and the ductwork situated therein with an aerosolized sealant, according to an exemplary embodiment.

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

Unless otherwise defined, the terms used herein have the same meaning as commonly understood by one of ordinary skill in the art encompassing the general inventive concepts. The terminology used herein is for describing exemplary embodiments of the general inventive concepts only and is not intended to be limiting of the general inventive concepts. As used in the description of the general inventive concepts and the appended claims, the singular forms “a,” “an,” and “the” are intended to include the plural forms as well, unless the context clearly indicates otherwise.

The general inventive concepts contemplate systems for and methods of sealing an attic of a building (or at least a floor of the attic) with an aerosolized sealant. In some exemplary embodiments, ductwork in the attic is sealed contemporaneously with the sealing of the attic.

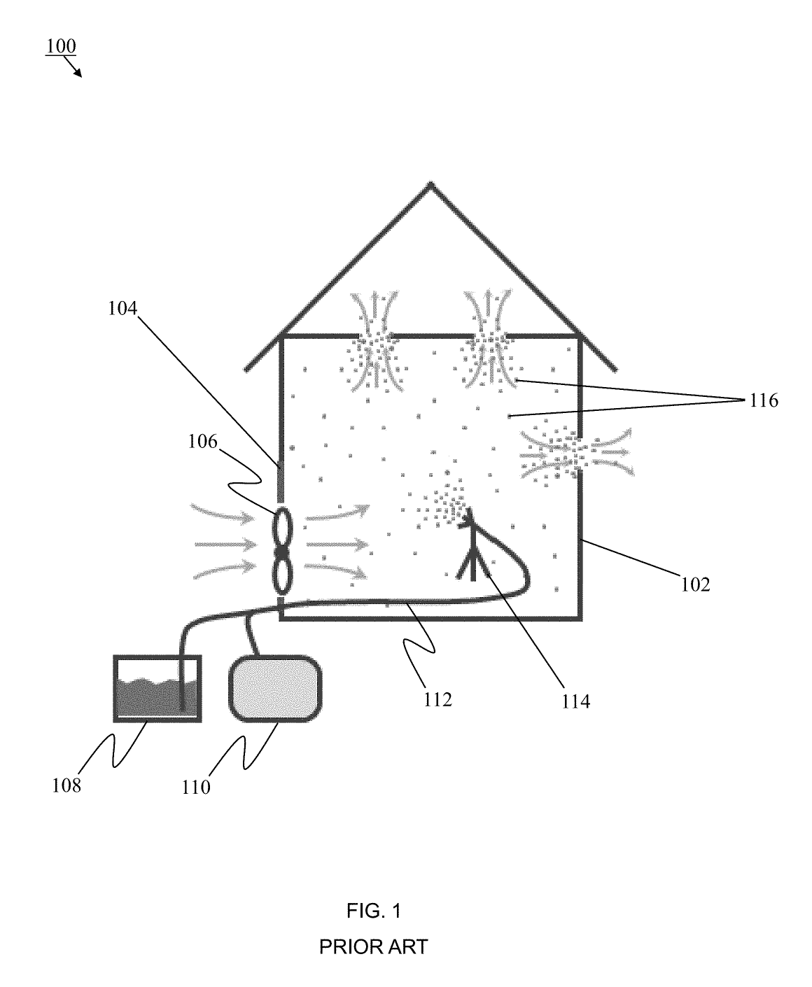

A conventional system 100 for sealing a house with an aerosolized sealant is shown in FIG. 1. In the system 100, the house 102 or similar structure is effectively sealed to increase its air tightness. For example, doors, windows, and other large openings are closed, covered, or otherwise sealed. A door seal 104 is used to seal a door of the house 102, wherein the door seal 104 has a fan 106 built in or otherwise interfaced therewith. The fan 106 is used to draw ambient air into and throughout the house 102.

The system 100 also includes a source of liquid sealant 108 and a source of air 110. The liquid sealant 108 and the air 110 are pumped through a hose 112 to an aerosol sprayer 114. The aerosol sprayer 114 atomizes the combination of the liquid sealant 108 and the air 110 to form aerosolized sealant particles 116.

A heater (not shown) is used to heat the air being drawn through the house 102 via the fan 106. The heater is used to increase the absolute humidity of the air being drawn through the house 102, since air having a higher temperature can accommodate more water vapor than air with a lower temperature. The air with the elevated temperature allows more of the liquid sealant 108 to be sprayed without overly saturating the air. In other words, the heater enables increased application rates.

The air being blown through the house 102 carries these sealant particles 116 throughout the home, such that as the particles pass through tiny openings within structures (e.g., walls) of the house 102, the particles 116 clump within and close (i.e., seal) the openings. Furthermore, because the air is heated, it facilitates curing (i.e., hardening) of the particles 116 which promotes the sealing. In this manner, the house 102 is better air sealed and should see an increase in its energy efficiency.

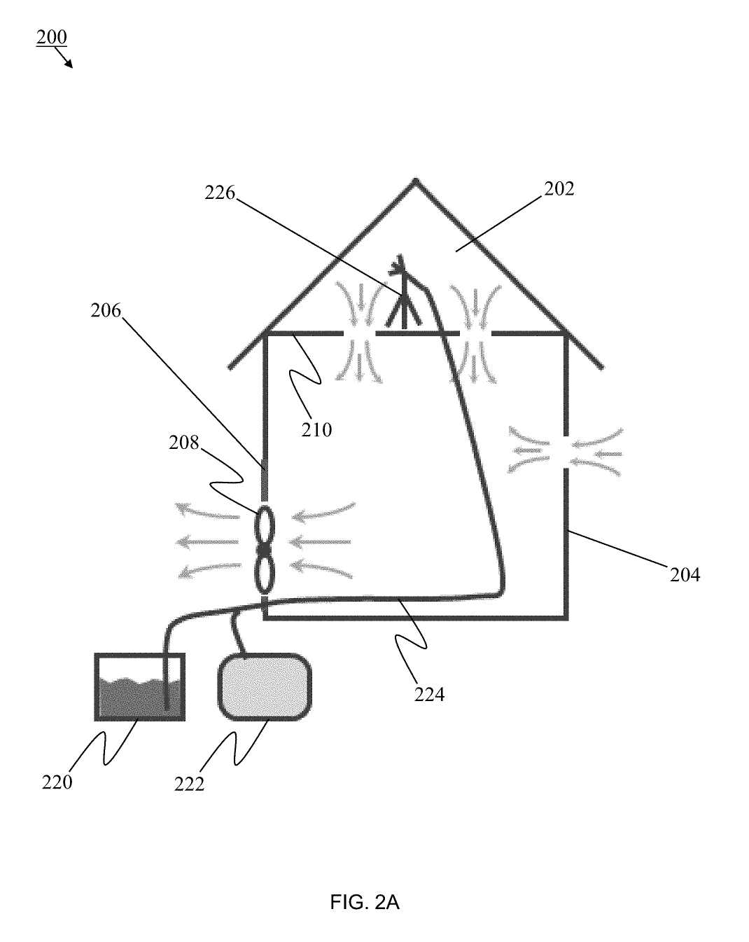

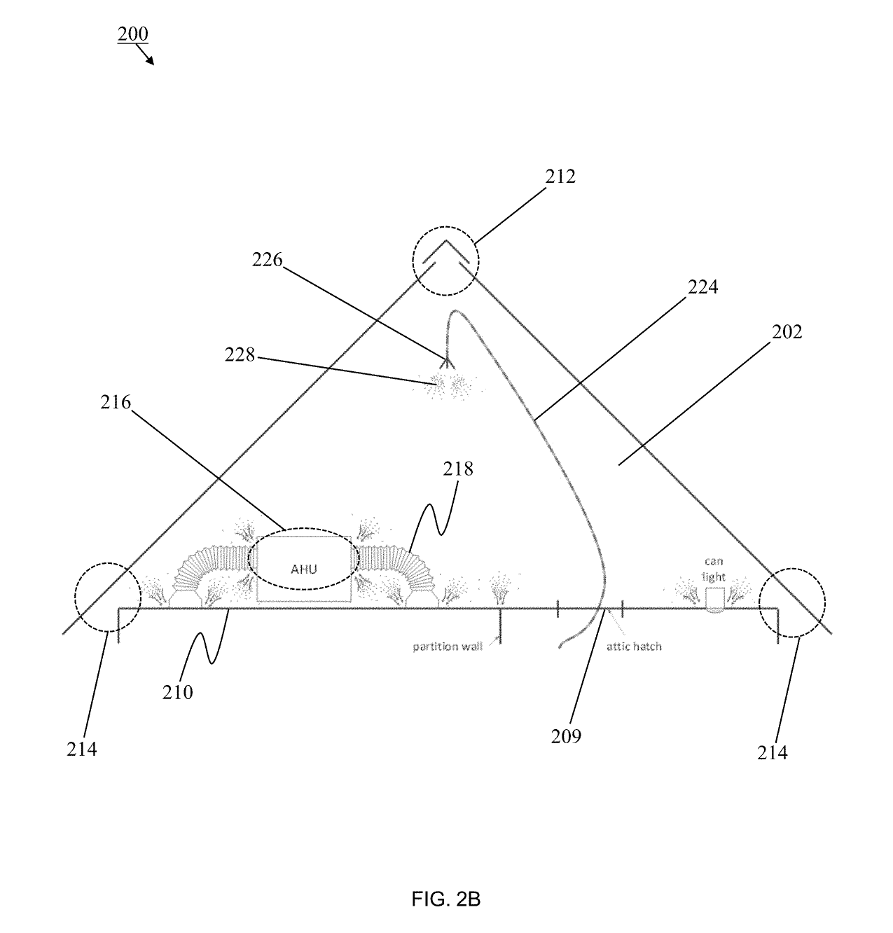

A system 200 for simultaneously sealing a floor of an attic in a house and the ductwork situated within the attic with an aerosolized sealant, according to an exemplary embodiment, is shown in FIGS. 2A-2B. In the system 200, an attic 202 of the house 204 is effectively sealed to increase its air tightness. For example, doors, windows, and other large openings of the house 204 are closed, covered, or otherwise sealed. A door seal 206 is used to seal a door of the house 204, wherein the door seal 206 has a fan 208 built in or otherwise interfaced therewith. The fan 208 is used to draw ambient air through and out of the house 204.

A heater (not shown) can be used to heat the air being drawn through the house 204, as described above for the conventional technology. However, in some exemplary embodiments, the system 200 may function without the need for any heater. This is beneficial since heating the air in the attic-only approach can be more difficult. In this approach, since air is being pulled through the attic 202, the heater would need to be carried to and situated in the attic 202, which would be inconvenient.

In some exemplary embodiments, only the attic 202 itself is sealed to increase its air tightness. In this case, the door seal 206 could be situated to seal a hatch 209 in a floor 210 of the attic 202. Other sources of airflow specific to the attic 202 would also be sealed, such as any ridge vents 212 and/or eave vents 214. Likewise, an air handling unit 216 or other HVAC equipment within the attic 202 might be sealed to prevent undesired entry of the aerosolized sealant 228 therein, while still allowing the aerosolized sealant 228 to close any small gaps or openings in the ducts 218 in the attic 202. In particular, interfaces between the ducts 218 and the air handling unit 216 or between the ducts 218 and the floor 210 of the attic 202 could still receive the aerosolized sealant 228.

The system 200 also includes a source of liquid sealant 220 and a source of air 222. In some exemplary embodiments, it may be possible to use a non-aqueous sealant. In some exemplary embodiments, it may be possible to use a sealant to which less water is added than in the conventional system. In general, the sealant 220 should (1) be atomized to a small enough diameter to enable transport by the air currents to crack locations; (2) be tacky/sticky when it reaches the crack locations; and (3) exhibit typical sealant properties in its final cured state (e.g., stopping air flow, not cracking).

The liquid sealant 220 and the air 222 are pumped through a hose 224 to an aerosol sprayer 226 or other applicator. The aerosol sprayer 226 atomizes the combination of the liquid sealant 220 and the air 222 to form aerosolized sealant particles 228. In some exemplary embodiments, a self-contained applicator that atomizes the liquid sealant 220 can be used, such that the hose 224 is not needed. In some exemplary embodiments, two or more aerosol sprayers 226 are used simultaneously to spray the aerosolized sealant 228 within the attic 202.

The air being drawn through the house 204 carries these sealant particles 228 throughout the attic 202, such that as the particles pass through tiny openings within structures (e.g., the floor 210) of the attic 202, the particles 228 clump within and close (i.e., seal) the openings. As noted above, heating of the air may increase the application rate of the sealant particles 228. Furthermore, heating of the air may facilitate curing (i.e., hardening) of the particles 228 which promotes the sealing. In this manner, the attic 202 (or at least the attic floor 210) is better air sealed and should provide an overall increase in the energy efficiency of the house 204.

Because of the reduced size and geometries of attics, as compared to entire homes, which can be a reduction of, for example, 40% to 70%, sealing of the attic floor and ductwork typically can be done more quickly, requiring less set-up time and less clean-up time. For example, there is little if any need to mask surfaces since errant spray is not typically an issue in an attic. Once inhabited, the time and cost associated with masking an entire home would likely be a deterrent to pursuing the energy benefits provided by conventional sealing technologies. Thus, the general inventive concepts overcome this disadvantage by focusing sealing efforts on the attic, which is often an unfinished space.

As another example, fewer applicators (e.g., aerosol sprayer 226) would likely need to be setup and afterward removed due to the smaller area to seal presented by an attic. Since the droplet path from the applicator to a crack is on average shorter in the attic, this should allow for the generation of a larger droplet that is still able to reach its destination via the provided air currents and/or other forces acting on the droplet. Not needing to produce finer droplets should enable a simpler, less costly nozzle and might eliminate the need to air-atomize the liquid sealant, which requires the presence of an air compressor on the jobsite and all the resulting drawbacks associated therewith (e.g., weight, cost, noise).

Often, the top of a house has a high concentration of air leakage sites, more so than other parts of the house. Thus, the approach of sealing only the attic (or portion thereof) is more targeted, resulting in less sealant usage per house (and corresponding lower cost), faster installation time, and potentially less disruption to occupants of the house.

Data associated with the use of aerosolized sealant technology on entire houses is available in the publication entitled Field Trial of an Aerosol-Based Enclosure Sealing Technology (available at http://www.nrel.gov/docs/fy15osti/64740.pdf as of May 22, 2017). This data shows that the sealing time for the studied homes ranged from 74 to 112 minutes and the sealant usage ranged from 4 to 10 gallons. Estimates for the attic-only approach, encompassed by the general inventive concepts, for comparable-sized houses predict a sealing time in the range of 10 to 30 minutes and sealant usage in the range of 1 to 3 gallons. This is greater than a two-thirds reduction in time and sealant usage.

Additionally, the shorter distance that a droplet has to travel on average in the attic, combined with the more forgiving application conditions (e.g., little/no consequence of droplet fallout/making a mess), could enable a broader family of sealants to be used. Furthermore, these more forgiving application conditions might also enable a simpler sealant application approach, for example, a fogging technology such as used in “insect fogger”/“bug bomb” applications.

The above description of specific embodiments has been given by way of example. From the disclosure given, those skilled in the art will not only understand the general inventive concepts and their attendant advantages, but will also find apparent various changes and modifications to the structures and concepts disclosed. It is sought, therefore, to cover all such changes and modifications as fall within the spirit and scope of the general inventive concepts, as defined herein and by the appended claims, and equivalents thereof.

What is claimed is:

1. A system for sealing one or more openings in an attic floor, the system comprising:
a fan for drawing air through one or more openings in a floor of an attic; and
an applicator for atomizing a liquid sealant to produce a plurality of sealant particles,
wherein the sealant particles travel to the openings in the floor and agglomerate with one another to seal the openings in the floor.

2. The system of claim 1, wherein the fan draws air through one or more openings in a duct situated in the attic; and
wherein the sealant particles travel to the openings in the duct and agglomerate with one another to seal the openings in the duct.

3. The system of claim 2, wherein the openings in the floor and the openings in the duct are sealed contemporaneously.

4. The system of claim 1, further comprising a heater for heating the air drawn by the fan.

5. The system of claim 1, wherein the sealing operation is complete within 10 minutes to 30 minutes.

6. The system of claim 1, wherein the sealing operation uses between 1 gallons to 3 gallons of the liquid sealant.

7. The system of claim 1, wherein the sealing operation uses a single applicator.

8. The system of claim 1, wherein the sealant particles are prevented from exiting the attic.
